(19) United States
(12) Patent Application Publication
(10) Pub. No.: US 2011/0122610 A1
(43) Pub. Date: May 26, 2011

(54) Lighting assembly With Air Cooling

(75) Inventors: Johannes Wilhelmus Weekamp, Eindhoven (NL); Marcus Jozef Van Bommel, Eindhoven (NL)

(73) Assignee: KONINKLIJKE PHILIPS ELECTRONICS N.V., EINDHOVEN (NL)

(21) Appl. No.: 13/055,503

(22) PCT Filed: Jul. 24, 2009
(86) PCT No.: PCT/IB09/53216

§ 371 Date: Jan. 24, 2011

(30) Foreign Application Priority Data
Jul. 31, 2008 (EP) 08161524.7

(51) Int. Cl. F21L 13/00

(52) U.S. Cl. 362/192

(57) ABSTRACT

A lighting device (2) generating excess heat has a cooling area cooled by a fluid flow generated by a fan device (10). A fan motor (6) driving the fan device has an electromagnetic motor circuit. Part of the electromagnetic motor circuit forms part of an electromagnetic generator circuit. The electromagnetic generator circuit supplies the lighting device. The combination of the electromagnetic motor and generator circuits provides a compact and low-cost construction which can be connected to a mains voltage without electric conversion. The lighting device may be an LED device.

### FIELD OF THE INVENTION

The present invention relates to the field of lighting, and more specifically to a lighting assembly having a lighting device generating excess heat to be removed by forced fluid flow.

### BACKGROUND OF THE INVENTION

Nowadays, LED (Light Emitting Diode) devices are used ever more frequently for lighting purposes by virtue of their high efficiency in the conversion of electric power input to light output, their small dimensions, their light color varieties available, and for other reasons. Individual LEDs are low voltage devices operable at voltages of e.g. 2 . . . 4 V. When supplying power to LEDs from a mains voltage of e.g. 220 V AC or 110 V AC, a conversion of voltage is therefore necessary. Such conversion requires a converter comprising different components like one or more transformers, semiconductor switches, inductors, etc. The converter adds considerable volume, weight and cost to a lighting assembly.

German Utility Model publication DE 20 2005 019 695 U1 discloses a lamp consisting of a housing, a generator provided in and connected to the housing, a balancing weight connected to the generator, and a light element. The generator operates on the basis of electromagnetic induction to generate power for the light element connected thereto.

According to FIG. 8 of DE 20 2005 019 695 U1, the lamp housing is mounted to a fan propeller hub which is driven by an electric motor. The light element, containing a plurality of LEDs, is provided at a front side of the housing, facing away from the axial end of the fan propeller hub. The balancing weight has a centre of gravity lying below the generator shaft to bring the generator shaft into rotation when rotating the lamp housing. An air flow generated by the fan propeller hub flows along the lateral sides of the housing.

With an increase of the power of LEDs, power losses therein may be substantial, requiring a large heat sink or an active cooling of the power LEDs by a fan device generating a cooling fluid flow for a convective cooling of the heat sink or the power LEDs.

### SUMMARY OF THE INVENTION

An object of the invention is to provide a lighting assembly which requires few components.

An advantage of the invention is its compactness.

In an embodiment, the lighting assembly of the invention comprises: a lighting device; a fan device; a fan motor for driving the fan device to generate a fluid flow; and a lighting generator for generating electric power to supply the lighting device. The fan motor has an electromagnetic motor circuit, and the lighting generator has an electromagnetic generator circuit, and part of the electromagnetic motor circuit forms part of the electromagnetic generator circuit. The lighting device has a cooling area for cooling the lighting device, and the fan device in operation generates a fluid flow along the cooling area of the lighting device.

Accordingly, the electromagnetic motor circuit and the electromagnetic generator circuit are combined to provide a compact unit which, when fed with electrical power, may act both as a motor for driving the fan device and as a generator for generating electrical power to supply the lighting device. Heat losses produced by the lighting device are removed by a fluid flow produced by the fan device. The fluid flows along the cooling area of the lighting device, which cooling area may be a housing or enclosure (or part thereof) of the lighting device, such as a glass or synthetic material container, or a heat sink being in thermal contact with the lighting device. In general, the fluid may be a gas or a liquid. In practice, the fluid may be air.

In an embodiment, the electromagnetic generator circuit comprises a generator coil located in a magnetic field generated in the electromagnetic motor circuit. The magnetic field may be stationary, with the generator coil moving relative to the stationary field. Alternatively, the magnetic field may be varying, with the generator coil being stationary. Also, a combination of a varying magnetic field and a moving generator coil is possible. In the generator coil, an AC voltage is generated which is used to supply a current to the lighting device. The current may be rectified, e.g. by any rectifier circuit, or by virtue of being output through a collector of a DC rotor winding, before being supplied to the lighting device.

The electromagnetic generator may be designed to generate a predetermined electrical power at a predetermined voltage. The power characteristics of the electrical generator may be different from the power characteristics of the electromagnetic motor. In an embodiment, the lighting generator is configured to supply a low voltage (e.g. 2-4 V), whereas the fan motor may be configured to receive a mains voltage (e.g. 110 or 230 V AC), without a separate electronic power converter being necessary to generate a low voltage for the lighting device.

In an embodiment, the fan motor and the lighting generator are rotary-type devices. In another embodiment, the fan motor and the lighting generator are oscillating-type devices, such as voice coil-type devices. An oscillating-type fan motor is e.g. disclosed in International patent application WO 2007/107921.

In an embodiment, the lighting device comprises at least one power LED. Accordingly, in an aspect of the invention, there is provided a power LED supply device, comprising: a fan device; a fan motor for driving the fan device to generate a fluid flow; and a lighting generator for generating electric power to supply at least one power LED. The fan motor has an electromagnetic motor circuit, and the lighting generator has an electromagnetic generator circuit, and part of the electromagnetic motor circuit forms part of the electromagnetic generator circuit. The fan device in operation generates a fluid flow along a cooling area of the at least one power LED.

In a further aspect, the invention provides a method of powering a lighting device, comprising: supplying electric power to the lighting device; and supplying power for generating a fluid flow for cooling the lighting device, wherein part of the power supplied for generating the fluid flow is electromagnetically converted to generate the electric power supplied to the lighting device.

The claims and advantages will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 schematically shows an embodiment of the present invention.

FIG. 2 schematically shows a further embodiment of the present invention.

FIG. 3 schematically shows part of the embodiment of FIG. 1 in more detail.

FIG. 4 shows a cross-section of another embodiment of the present invention.

### DETAILED DESCRIPTION OF EMBODIMENTS

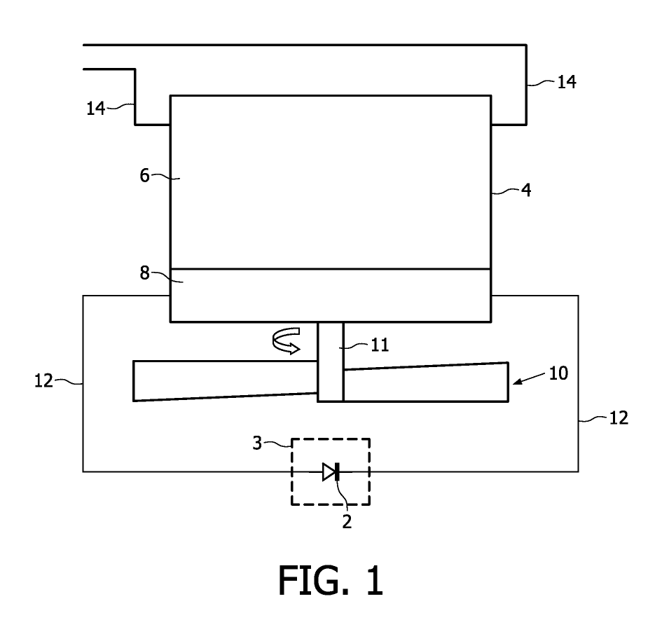

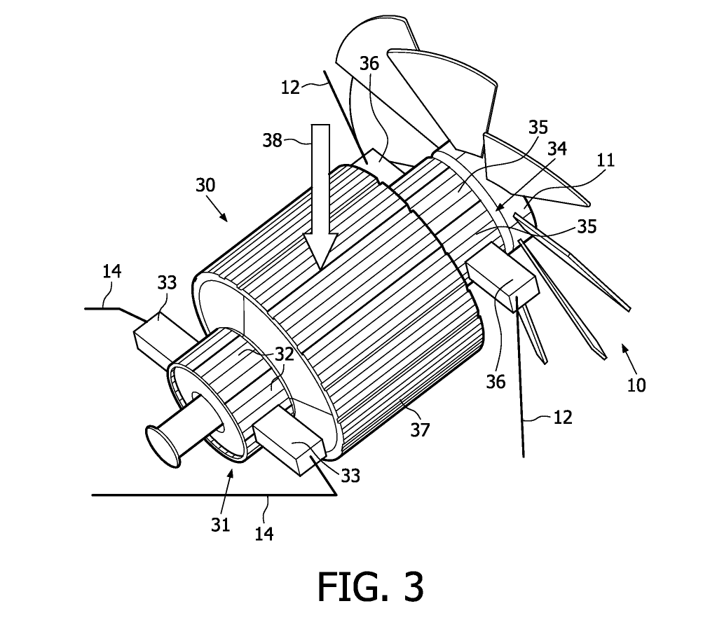

FIG. 1 shows a lighting assembly comprising a lighting device embodied as a LED 2, such as a power LED generating substantial heat losses which need to be removed by forced cooling. A housing 4 contains a rotating motor 6 and a rotating generator 8, the motor 6 driving a rotatable fan 10 having an axis of rotation 11. The motor 6 and the generator 8 are mechanically coupled, and in operation the motor 6 drives the generator 8 as well as the fan 10. Part of the electromagnetic circuit of the motor 6 is part of the electromagnetic circuit of the generator 8, as will be illustrated in more detail in FIG. 3. The LED 2 is electrically coupled to the generator 8 by lines 12 such that electrical power generated by the generator 8 is supplied through the lines 12 to the LED 2 which thereby provides light of a predetermined color and intensity. The generator 8 generates AC or DC power of a low voltage of e.g. 2-4 V adapted for the LED 2. The motor 6 is powered by a mains voltage through lines 14, usually 230 V or 110 V AC, 50 Hz or 60 Hz.

Thus, by providing mains power to the motor 6, the motor 6 will rotate, and rotatably drive the generator 8 and the fan 10. In turn, the generator 8 will supply electrical power to the LED 2. In operation, the LED 2 will generate light and heat. The heat will be removed from the LED 2 by a fluid flow generated by the fan 10 in operation. As indicated by dashed lines, a heat sink 3 may be thermally coupled to the LED 2, where a fluid flow generated by the fan 10 will cool the heat sink 3.

When the generator 8 is of an AC type, the duty cycle of the LED 2 is only about 50%, and the light generated by the LED may flicker visibly, in particular when the motor 6 is running up from standstill.

Alternatively, an AC generator 8 may be coupled to a rectifier circuit (not shown), such as a half-bridge or full-bridge rectifier circuit, and a rectified voltage produced by the rectifier circuit may be supplied to the lighting device, in particular the LED 2, thereby increasing the duty cycle to about 100%.

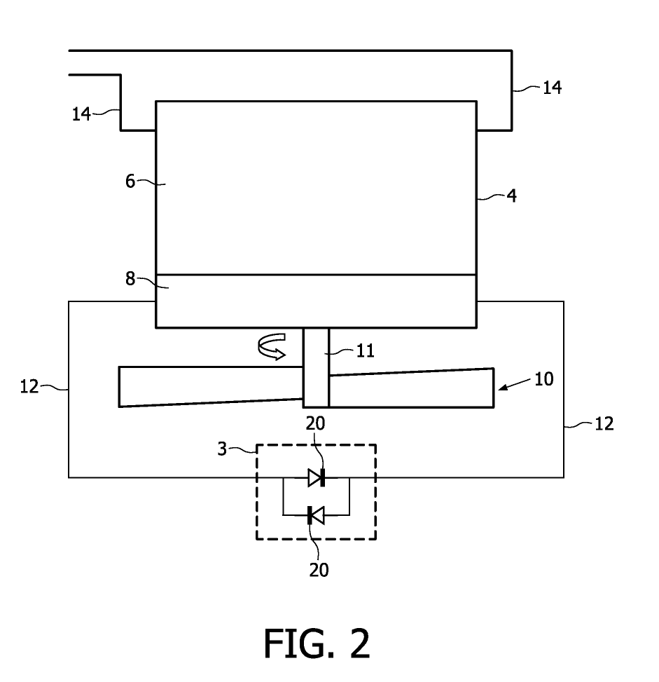

FIG. 2 shows an embodiment similar to FIG. 1. Instead of one LED 2 connected between the lines 12 according to FIG. 1, FIG. 2 shows two LEDs 20 connected anti-parallel between the lines 12. In the latter configuration, the light output is doubled when compared to the configuration of FIG. 1, since current may flow through one of the two LEDs during a complete cycle of an AC voltage generated by the generator 8.

FIG. 3 shows an embodiment of part of a motor/generator assembly and a fan, as may be used in the circuit of FIG. 1. A fan 10 mounted to an axis of rotation 11 is coupled to a rotor 30 of a DC motor/generator assembly. A first collector ring 31 having segments 32 made from a conductive material is in electrical contact with brushes 33, which are connected to a stationary housing structure, or stator structure, not shown in detail. The brushes 33 are electrically connected to DC voltage input lines 14. A second collector ring 34 having segments 35 made from a conductive material is in electrical contact with brushes 36, which are connected to said housing or stator structure. The brushes 36 are electrically connected to DC voltage output lines 12.

The segments 32 are electrically connected to a rotor motor winding (not shown in detail) mounted on a main body 37 of the rotor 30. The segments 35 are electrically connected to a rotor generator winding (not shown in detail) mounted on the main body 37. At least part of the main body 37 is made from a magnetically conducting material. The rotor 30 is placed in an essentially stationary magnetic field having a direction 38 substantially at right angles to the extension of the axis of rotation 11. Such magnetic field may e.g. be generated in a manner known per se by permanent magnets located opposite to each other at the cylindrical surface of the main body 37. The permanent magnets may form a stator. Instead of permanent magnets, also electromagnets energized by a DC current may be used.

By applying a DC voltage on the lines 14, a DC current will flow through the lines 14, the brushes 33, the segments 32 contacted by the brushes 33 and the rotor motor winding connected to the segments 32, and the rotor 30 will rotate in a direction determined by the polarity of the current and the polarity of the magnetic field. As a result of this rotation, a voltage will be generated in the rotor generator winding, and will be present on the lines 12. When the lines 12 are connected to a lighting device, such as one or more diodes 2, a DC current will flow through the lighting device, the lines 12, the brushes 36, the segments 35 contacted by the brushes 36, and the rotor generator winding connected to the segments 35. The lighting device may be cooled by a fluid (e.g. air) flow generated by the fan 10.

In the construction of FIG. 3, the main body 37 is part of the electromagnetic motor circuit, and part of the electromagnetic generator circuit. The DC voltage for operating the rotor motor winding may be different from the DC voltage generated by the rotor generator winding.

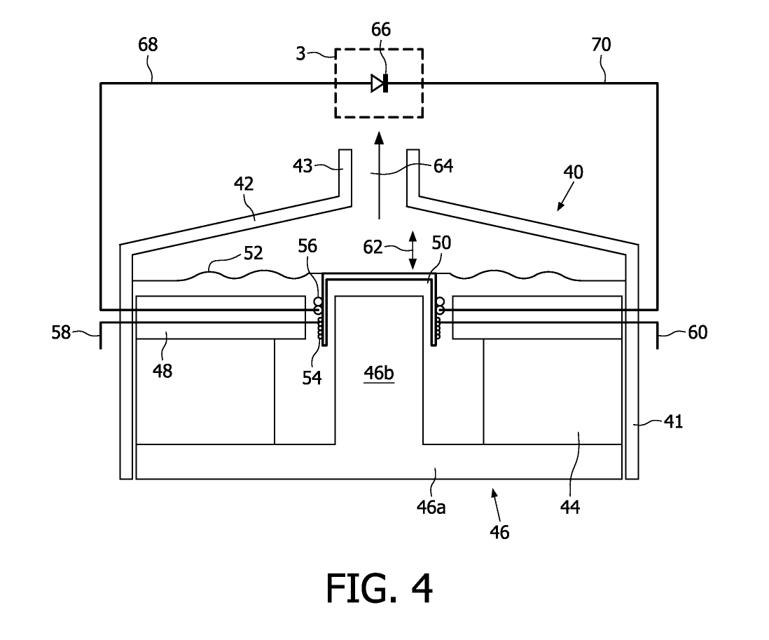

As an alternative to cooling by a rotating fan, International patent application WO 2007/107921 discloses a pulsating fluid cooling device comprising a transducer adapted to generate pressure waves at a drive frequency, a tube, having a first end adapted to receive said pressure waves from the transducer, and a second end adapted to generate a pulsating net output flow towards the object. The tube acts as a transmission line that applies a velocity gain to the pulsating flow. FIG. 4 shows such a pulsating fluid cooling device.

FIG. 4 shows a housing 40 comprising a generally cylindrical first housing part 41, a generally frusto-conically second housing part 42, and a generally cylindrical third housing part 43. A ring-shaped magnet 44 (permanent magnet or electromagnet) is situated between a lower yoke part 46, comprising a disc-shaped base part 46a and a central cylinder-shaped part 46b, and an upper yoke part 48, being ring-shaped. The yoke parts 46 and 48 are made from a magnetizable material. In an air gap between an inner surface of the upper yoke part 48 and an end section of the central cylinder-shaped lower yoke part 46b, a support 50 mounted on a membrane 52 is located. The support 50 carries an actuator coil 54 and a generator coil 56, normally, but not necessarily electrically isolated from one another. A magnetic field generated by the magnet 44 is directed substantially radially in the air gap.

When the actuator coil 54 is powered by an AC voltage, such as a mains voltage, through lines 58, 60, the support 50 will oscillate in the directions indicated by double arrow 62, thereby moving the membrane 52, in particular the central part thereof. Consequently, an air flow will be generated by the membrane 52, leaving the housing 40 through the opening of the third housing part 43, as indicated by the arrow 64. A lighting device, such as a LED 66, is placed in the path of the fluid flow generated by the membrane 52, and is cooled by this fluid flow. The LED 66 is electrically connected to the generator coil 56 by lines 68, 70, and powered by electrical energy generated by the generator coil 56 when oscillating with the support 50 together with the actuator coil 54 in the magnetic field generated in the air gap.

Thus, by providing electrical power to the actuator coil 54, the support 50 will oscillate, and oscillatingly drive the generator coil 56 and the membrane 52. In turn, the generator coil 56 will power the LED 66. In operation, the LED 66 will generate light and heat. The heat will be removed from the LED 66 by an air flow generated by the membrane 52 in operation.

In the embodiment shown in the Figures, a single LED 2 may be replaced with a number of series and/or parallel connected LEDs. An LED may also be replaced by any other type of lighting device, such as one or more incandescent lamps, or one or more gas discharge lamps.

In accordance with the present invention, a lighting device generating excess heat has a cooling area cooled by a fluid flow generated by a fan device. A fan motor driving the fan device has an electromagnetic motor circuit. Part of the electromagnetic motor circuit forms part of an electromagnetic generator circuit. The electromagnetic generator circuit supplies the lighting device. The combination of the electromagnetic motor and generator circuits provides a compact and low-cost construction which can be connected to a mains voltage without electric conversion. The lighting device may be an LED device, such as a power LED device.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. Any reference signs in the claims should not be construed as limiting the scope.

The terms “a”, “an”, “first”, “second” etc. as used herein, are defined as one or more than one. The term plurality, as used herein, is defined as two or more than two. In addition, singular references do not exclude a plurality. The term another, as used herein, is defined as at least a second or more. The terms including and/or having, as used herein, are defined as comprising (i.e., open language). The term coupled, as used herein, is defined as connected, although not necessarily directly, and not necessarily mechanically.

1. A lighting assembly comprising:
a lighting device (2);
a fan device (10);
a fan motor (6) for driving the fan device to generate a fluid flow; and
a lighting generator (8) for generating electric power to supply the lighting device,
wherein the fan motor has an electromagnetic motor circuit, and the lighting generator has an electromagnetic generator circuit, and part of the electromagnetic motor circuit forms part of the electromagnetic generator circuit, and
wherein the lighting device has a cooling area for cooling the lighting device, and the fan device in operation generates a fluid flow along the cooling area of the lighting device.

2. The lighting assembly of claim 1, wherein the electromagnetic generator circuit comprises a generator coil located in a magnetic field generated in the electromagnetic motor circuit.

3. The lighting assembly of claim 1, wherein the lighting generator is configured to supply a low voltage.

4. The lighting assembly of claim 3, wherein the low voltage is between 2-4 V.

5. The lighting assembly of claim 1, wherein the electromagnetic motor circuit comprises a motor coil configured to be energized by a mains voltage.

6. The lighting assembly of claim 1, wherein the fan motor and the lighting generator are rotary-type devices.

7. The lighting assembly of claim 1, wherein the fan motor and the lighting generator are oscillating-type devices.

8. The lighting assembly of claim 7, wherein the fan motor and the lighting generator are voice coil-type devices.

9. The lighting assembly of claim 1, wherein the lighting device comprises at least one power LED (2).

10. The lighting assembly of claim 1, wherein the cooling area comprises a heat sink (3) being in thermal contact with the lighting device.

11. A power LED supply device, comprising:
a fan device (10);
a fan motor (6) for driving the fan device to generate a fluid flow; and
a lighting generator (8) for generating electric power to supply at least one power LED (2),
wherein the fan motor has an electromagnetic motor circuit, and the lighting generator has an electromagnetic generator circuit, and part of the electromagnetic motor circuit forms part of the electromagnetic generator circuit, and
wherein the fan device in operation generates a fluid flow along a cooling area of the at least one power LED.

12. A method of powering a lighting device, comprising:
supplying electric power to the lighting device (2); and
supplying power for generating a fluid flow for cooling the lighting device;
wherein part of the power supplied for generating the fluid flow is electromagnetically converted to generate the electric power supplied to the lighting device.
